(19) United States
(12) Patent Application Publication
(10) Pub. No.: US 2007/0227555 A1
(43) Pub. Date: Oct. 4, 2007

(54) Method to manipulate post metal etch/side wall residue

(76) Inventors: Michael R. Johnson, Colorado Springs, CO (US); Timothy A. Crump JR., Colorado Springs, CO (US)

Correspondence Address: SCHNECK & SCHNECK, P.O. BOX 2-E, SAN JOSE, CA, 95109-0005, US

(21) Appl. No.: 11/397,836

(22) Filed: Apr. 4, 2006

(51) Int. Cl. B08B 6/00; B08B 3/00; C23G 1/00

(52) U.S. Cl. 134/1.3; 134/2; 134/1.1; 134/26

(57) ABSTRACT

A method of semiconductor manufacturing to treat sidewall residue such that the side wall remains substantially vertical or peels back from the resist prior to removal of the resist by ashing or other means.

### TECHNICAL FIELD

The present invention relates to semiconductor manufacturing methods and more specifically to post metal etch treatments of semiconductors.

### BACKGROUND OF THE INVENTION

During the manufacture of semiconductor devices (e.g., integrated circuits) numerous devices are manufactured on a single substrate. These devices are then interconnected using conductive structures formed in layers on the substrate. Interconnection of these traces forms electrical circuits. Formation of these circuits requires manufacturing a multiple level network in layers formed over the substrate. Individual conductive layers within the multiple layer network are formed by depositing an insulating or dielectric layer over a substrate, such as a silicon wafer. A pattern is etched in the dielectric layer to form cavities such as vias and trenches. At least one conductive material is then deposited in and over the cavities. The conductive material is patterned with photoresist and then etched to form the horizontal metal lines and vertical conductive structures that allow electrical interconnect of the devices.

In some devices, the fabrication sequence includes silicon dioxide as a dielectric layer, at least one metal layer, and a photoresist. The photoresist is exposed using a mask and developed and etched to selectively remove areas to create the desired patterns on the substrate. In the created pattern of removed layers, a polymer sidewall typically forms over the various layers. These sidewalls include both organic and inorganic material.

During metal etch processing with thick photoresist (e.g., resist greater than 12,000 Angstroms (Å)), the sidewall polymer produces build-up on the etched metal lines as well as on the remaining photoresist that was not exposed and thus was not removed during the etch process. This polymer forms a continuous sidewall residue that has a height greater than the stack being etched. This poses a problem when the substrate moves to a post-etch ash step. During this step, high temperature oxygen plasma processing is used to remove the remaining layer of thick photoresist. Typically, as the remaining photoresist is removed by high temperature oxygen plasma processing, the continuous sidewall polymer layer collapses inward over the top of the etched metal lines. This collapse may block the resist removal.

With reference to FIG. 1, the sidewall polymer 14 is formed as a by-product of the etch. This sidewall acts as a passivation layer to protect the emerging metal lines during etch. Sidewall polymer 14 extends from the substrate 10 spanning both conductor 12 and resist layer 16. When the substrate moves to the subsequent ashing step, this sidewall polymer collapses inward as the photoresist is ashed away. In FIG. 2, the photoresist is shown after partial removal. Sidewall 14 has collapsed to form bending projections 20, which partially covers resist 16 overlaying conduction layer 12 on substrate 10. These projections shield the remaining photoresist during the ashing process and prevent the effective removal of the resist. Thus, the processing requires a step to remove the polymer (using a solvent) and a second ash step to remove the remaining resist that was trapped by the pending projections 20.

In prior device manufacturing methods this problem has been addressed in a number of ways. One method is to perform a primary ash step followed by steps to clean the device and remove the sidewall polymer. Then a secondary ash step is completed to ensure that both the sidewall and the photoresist have been removed.

The present invention provides a method of sidewall treatment that allows manipulation of the sidewall residue in such a manner as to prevent it from becoming a barrier during the removal of the photoresist by an ashing process. This allows for complete removal of the photoresist without the need for a follow up reashing step.

### SUMMARY OF THE INVENTION

The present invention includes a method in which the sidewall polymer is treated to remove ions, including chlorine ions, to ensure that the sidewall will remain vertical or peel back from the photoresist. During the photoresist removal, the sidewall will not collapse over the photoresist as the photoresist is removed in the ashing step.

In one embodiment, this method requires treating the semiconductor with water vapor at 250° C. at two Torr pressure, followed by treating the device to water vapor plasma at 250° C. at two Torr pressure. The plasma is generated using, for example, 800 W microwave power.

Following the sidewall treatment the photoresist may be removed using a lower temperature (e.g., 250° C. rather than 275° C.) and without requiring a secondary re-ashing step. Following photoresist removal, the sidewall may be removed in a conventional manner (e.g., using solvents).

### BRIEF DESCRIPTION OF THE DRAWINGS

FIG. 1 is a side cutaway of an etched metal line of the prior art having a thick overlaying resist layer and adhering sidewall polymers.

FIG. 2 is the side cutaway view of FIG. 1 after a primary ashing step in which some of the photoresist is removed and the sidewalls have collapsed.

FIG. 3 is a side cutaway view of an etched metal line in which the treatment of the present invention causes the sidewall to be stripped back.

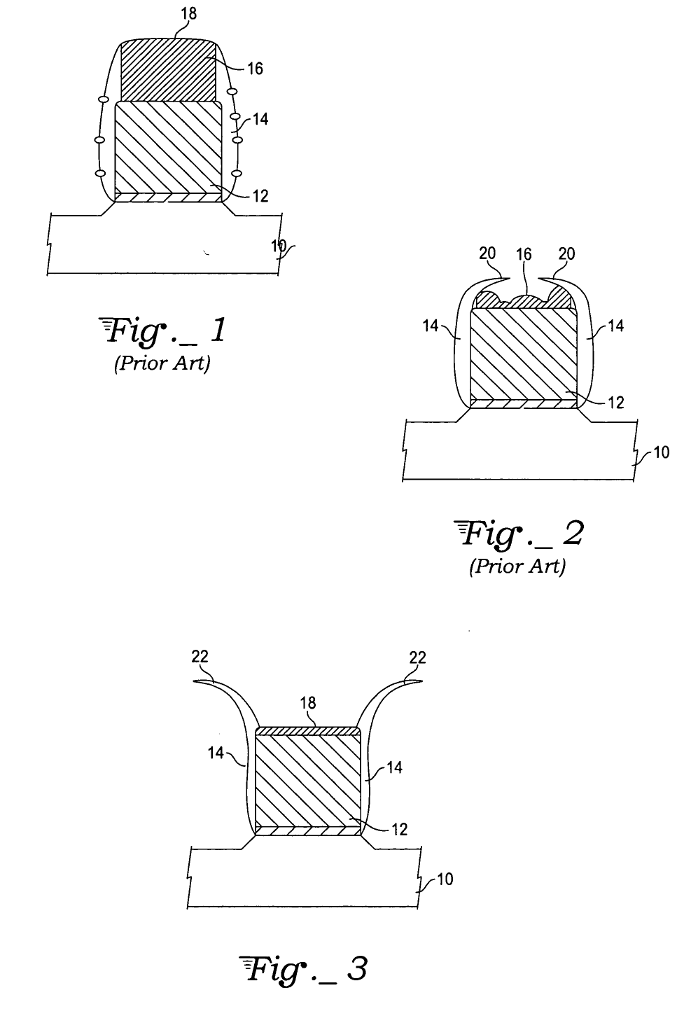

### DETAILED DESCRIPTION OF THE INVENTION

In the present invention, an improvement to the manufacturing process involves a step following etching of the resist and metal layers, prior to the removal of the sidewall polymer by a chemical stripping treatment. In this process the sidewall polymer is treated to remove the chlorine from the sidewall. This chlorine removal step causes the sidewall to either remain substantially vertical during the ashing step or to peel back away from the etched lines.

An exemplary embodiment of the process includes the following treatments:
1. Following the etching of the metal lines but prior to the ashing step, the semiconductor substrate is exposed to deionized (DI) water vapor at a pressure of two Torr and a temperature of 250° C. for 15 seconds.
2. Following step 1, the substrate is exposed to water plasma at a pressure of two Torr and a temperature of 250° C. using a microwave power of 800 W for 30 seconds. Alternative ranges have been tested at 240° C to 270° C. and pressure at 1.6 to 2.5 Torr. The wattage for this step is low power (defined as 40-60% of the power of the ash step.)
3. Following this treatment the resist may be removed by ashing. By using steps 1 and 2 above, the removal of the photoresist may be accomplished using a lower temperature and lower power. In one specific example, the ash step takes 35 seconds, and is performed at a pressure of two Torr and a temperature of 250° C. The microwave power is set at 1400 Watts. The plasma is generated using an O₂ flow rate at 1500 standard cubic centimeters per minute (sccm), H₂O at 250 sccm and CF₄ at 100 sccm. In other embodiments, complete resist removal can be achieved without the presence of CF₄ in this step.
4. Following removal of the resist by ashing, the now exposed interior sidewalls of the polymer may be treated by additional water vapor plasma to remove chlorine residuals.
   The effect of this treatment is seen in FIG. 3. As seen in FIG. 3, on the substrate 10 is deposited metal line 12. On the sides of the metal line 12 are sidewall polymer residue 14. Over the top of the metal line 12 is a topcrust 18. The sidewall 14 has peeled away from the resist forming arms 22. Arms 22 peel away from the photoresist such that the resist may be fully removed during the ashing step without being blocked or shielded by an inward collapse of the polymer sidewall.

The water vapor saturation and water vapor plasma steps remove the chlorine and other ions embedded in the sidewall polymer. One reason for removing the chlorine is to minimize the potential for any adverse reactions that may occur. For example, the chlorine may react with aluminum in a metal line to erode the etched metal lines. In addition to being corrosive to the etched metal lines, the ions in the sidewall residue also act as structural support for the sidewall polymer. Thus, by removing the ions in the manner described, it is possible to control shape of the sidewall as the photoresist is removed during the ash step. This prevents the sidewall from collapsing in over the resist to form a block and instead remain vertical or peel back from the resist.

The process of the present invention provides for a method to manipulate the post etch sidewall polymer in such a manner as to provide for complete post-etch photoresist removal. This method eliminates the need for repeating the post-metal etch ashing step after the removal of the polymer by a solvent or other means. The process is valid on various photoresists, including I-line and DUV resists, up to a thickness of about 21,000 Å.

Under the disclosed method, there is no critical dimension loss or attack of features such as an oxide foot, barrier metal, or titanium nitride (TiN) anti-reflective coating depositions. In corrosion tests, the devices made by the method described in this section had results equal to devices made by the prior process which required re-ashing.

A number of alternations in the disclosed methods are possible. In the exemplary embodiment disclosed above, the first step is a H₂O flood step, followed by a second flood step at relatively low power (40-60% of the power of the ash step). Alternatively, this second step may be a higher power H₂O plasma step (DI water vapor exposure at a relatively high power, such as substantially the same power as is used in the third step (the ash step)), essentially 100% of the power level of the third step. Thus, if 1400 to 1500 W is used for the ash step, 1500 W could be used for this second step.

What is claimed is:

1. A process for treating post etch semiconductors having etched metal lines, the etched metal lines having a thick overlaying photoresist and post etch sidewall residue, the process comprising:
treating the semiconductor with water vapor for a selected interval at a selected time pressure and temperature; and
sequentially treating the semiconductor with a water plasma for a selected time interval and at a selected pressure and temperature such that said sidewall remains substantially vertical or peels back from said photoresist.

2. The process of claim 1, wherein said selected temperature for each step is 250° C.

3. The process of claim 1, wherein the pressure for each step is two Torr.

4. A process for semiconductor manufacturing, the process comprising:
providing a semiconductor device including etched metal components and a thick photoresist overlaying the etched metal components and a sidewall polymer;
treating the semiconductor with water vapor for a selected time interval at a selected pressure and temperature;
sequentially treating the semiconductor with a water plasma for a selected time interval and at a selected pressure and temperature such that said sidewall remains substantially vertical or the photoresist peels back from said etched metal lines; and
removing the photoresist.

5. The process of claim 4 wherein said selected temperature for each step is 250° C.

6. The process of claim 4, wherein the pressure for each step is two Torr.

7. The method of claim 4, wherein removing the photoresist includes a single ashing step and no re- ashing step.

8. The method of claim 4, wherein removing the side wall polymer includes treating the semiconductor device with a solvent.

9. A method of manufacturing semiconductor devices, the method comprising:
providing a semiconductor device including etched metal components and a thick photoresist overlaying the etched metal components; and a sidewall polymer;
removing an ion component of said sidewall polymer including chlorine ions such that said sidewall element does not collapse over said photoresist during a removal of said photoresist; and
removing the photoresist.

10. The method of claim 9, wherein removing the photoresist includes a single ashing step and no re-ashing step.
